(19) United States
(12) Patent Application Publication
(10) Pub. No.: US 2008/0223497 A1
(43) Pub. Date: Sep. 18, 2008

(54) Tire Inner Tube

(76) Inventor: John Balzowski, Livermore, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/687,563

(22) Filed: Mar. 16, 2007

(51) Int. Cl. B60C 5/04

(52) U.S. Cl. 152/454

(57) ABSTRACT

The present invention is an inner tube apparatus, and article of manufacture, that comprises an inflatable compartment capable of surrounding a wheel. The tube comprises a first and second end that allows the user to replace the inner tube without removing the wheel, or other elements of the vehicle, for repair.

### I. BACKGROUND OF THE INVENTION

A. Field of the Invention

The invention broadly relates to inner tubes for tires. The applications include inner tubes for bicycles, motorcycles, and other wheeled devices.

B. Prior Art

Inner tubes for tires are well known in the art. They generally comprise inflatable rubber compartments capable of surrounding the wheel and cushioning the vehicle and occupants from vibrations and irregularities in road surfaces. Inner tubes are used in all manner of tires, including those used with motorcycles, bicycles, and automobiles. A problem with inner tubes is that they can be punctured, which deflates the tube and creates a “flat tire”. Many people encounter difficulty repairing or replacing the inner tube since it typically involves removing the wheel and possibly other parts as well. This may require the use of specialized tools and/or skills that the user lacks.

It is therefore often the case that the user must bring the bicycle or motorcycle to a professional for repair. In other situations, even when the user has the tools needed to make the repairs, the flat tire occurs in a location where the user does not have access to the required tools. There is therefore a need in the art for an inner tube that is easily installed without the need for special tools, and further that can be accomplished quickly and easily.

A variety of inner tube designs exist in the prior art. Hsu (U.S. Pat. No. 6,209,600 describes an inner tube with multiple air cells and breakers for protection against piercing. As with most inner tube designs, Hsu utilizes a tube with a fully annular shape.

Aflague (U.S. Pat. No. 5,385,191) describes a pneumatically-inflated inner tube having two compartments such that if one compartment is damaged and deflates, the other compartment may be inflated without removing the tire. The compartments inflate independently of each other using separate valves; each compartment has its own valve for inflation. When inflated, the two compartments surround the same annular axis. The two embodiments described have primary and secondary compartments. In the first embodiment, each compartment is a discrete component wherein the secondary compartment is disposed inside the primary compartment. The compartments connect where the valve of the secondary compartment projects through an aperture in the primary compartment. In the second embodiment, the two compartments form an integral unit. The compartments share a common surface such that one compartment is formed inside the other compartment. The primary compartment inflates using a valve disposed on the common surface which terminates at an aperture open to the primary compartment. The secondary compartment inflates using a valve disposed on the common surface in which the aperture opens to the secondary compartment. However, Aflague also utilizes tubes that are fully annular (form a complete and cohesive circle). In addition to other distinctions, the invention described herein utilizes a non fully annular tubular compartment.

### II. SUMMARY OF THE INVENTION

Accordingly, an object of the present a method and apparatus is to allow the replacement of an inner tube quickly and easily.

The present invention is an inner tube apparatus, and method of use, that comprises a non fully annular inflatable compartment capable of surrounding a wheel. This arrangement allows the user to replace the inner tube without removing the wheel, or other elements of the vehicle, for repair. The user of this invention would only need to remove the existing inner tube, which could be accomplished by cutting the tube (if originally fully annular) and pulling it away from the wheel. The user could then simply place the non fully annular inner tube around the wheel under the tire, then inflate the inner tube.

The invention described herein is somewhat similar to already existing tire inner tubes in that it is a generally circular tube acting as an air bladder with an air valve stem installed within. However, this invention changes this configuration. The invention described herein has a break somewhere in the circumference. Or, in other words, both of the ends of a non circular tube are sealed off in order to maintain an airtight seal. Placement of the valve stem is not critical to function, but is preferably placed near the center of the two ends to facilitate installation.

An advantage of the invention described herein over conventional inner tube designs is that the removal of the wheel from the vehicle in order to replace the tube becomes unnecessary. With respect to most forms riding, particularly off-road riding, a flat tire is a common occurrence. Often, it is commonplace to repair a tire while out on the trail. With an inner tube of this design, it greatly reduces the number of tools that you would need to carry with you on a ride for repairs.

The changing of a motorcycle inner tube may require the removal of a wheel, the disconnection and reconnection of the brakes, speedometer, drive chain/shaft etc. This can be complicated and labor intensive. Therefore even when a rider might be willing to change an inner tube of a tire, the accompanying repairs are often beyond the average person.

If one was using this invention in a home or shop environment, it greatly reduces the amount of time and labor involved in replacing a tire inner tube. On the road or on the trails, this could mean the difference between being stuck with a flat tire, and a quick and easy repair. When riding a bicycle or motorcycle, it is difficult to carry a large number of tools. Many such vehicles do not have sufficient storage for such items. This invention obviates the need to carry the tools necessary to remove a wheel, which are typically large and heavy.

An embodiment for the invention described herein comprises a tube formed into a “circular cylinder” shape that includes a break or disconnection somewhere in the circumference. There are different methods of sealing the open ends of the tube. These include the following: A cap, or a “cup” could be placed over the open ends of the tube and bonded into place. Another embodiment seals the open ends by pinching each end together and bonding them.

Another method includes molding the entire tube as one piece with no open areas to seal. This last embodiment may be the most durable of the embodiments disclosed herein. Any of these methods would make the entire tube airtight, while still allowing it to function as described. A conventional valve stem could be installed at a point along the length of the tube to allow the user to inflate the tube. It is recommended that the valve be placed approximately in the middle of the two ends of the tube.

An alternative method of constructing the invention is to simply make a “straight” tube. Such a configuration should be approximately the same length as the circumference of the appropriate sized tube, but it would not need to be formed into a circle. It could be a straight tube, sealed at both ends (with any of methods previously described) with a conventional valve stem, preferably installed in the middle of the tube between the two ends. However, the location of the valve is not critical to the function of the invention.

There are several different sizes of tire tubes currently offered for different applications, and the invention described herein can be offered in a variety of sizes to fit various applications. The method of using this invention includes accessing the original (flat) tube by removing one side of the tire “bead” from the wheel in order to expose the inside of the tire where the tube is located. The old tube is cut or torn apart to remove it from the motorcycle or bicycle completely. The invention can now be installed inside the tire without any interference from the other components of the vehicle due to the novel elements of its design. The tire “bead” can then be reinstalled, and the tire can then be inflated normally.

### III. BRIEF DESCRIPTION OF THE DRAWINGS

FIG. 1 shows a perspective view of a generally circular shaped embodiment of the invention.

FIG. 2 shows a perspective view of an embodiment of the invention where the tube is molded into a generally straight shape.

FIG. 3 shows a perspective view of a generally circular shaped embodiment of the invention.

FIG. 4 illustrates a perspective view of an embodiment of the invention.

FIG. 5 illustrates a perspective view of an embodiment of the invention.

FIG. 6 illustrates a perspective view of an embodiment of the invention.

FIG. 7 illustrates a semi transparent perspective view of an embodiment of the invention.

FIG. 8 illustrates a semi transparent side view of an embodiment of the invention.

FIG. 9 illustrates a semi transparent side view of an embodiment of the invention.

FIG. 10 illustrates a semi transparent perspective view of an embodiment of the invention.

FIG. 11 illustrates a semi transparent perspective view of an embodiment of the invention.

### IV. DETAILED DESCRIPTION OF THE INVENTION

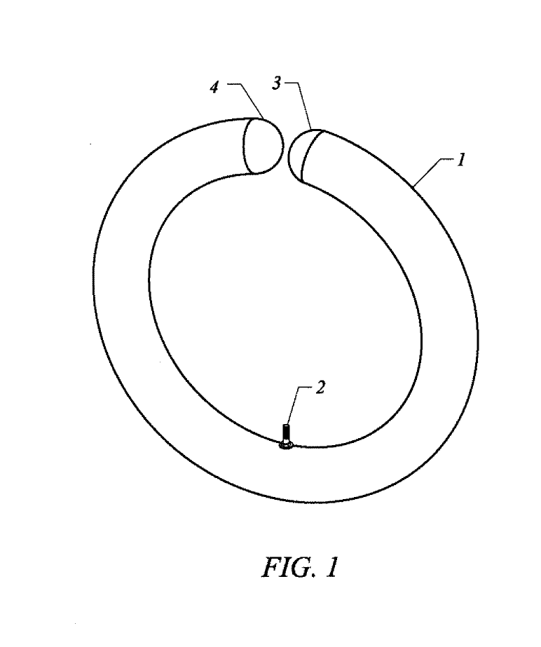

FIG. 1 shows a perspective view of an embodiment of the invention. The tube shown in this figure is molded into a circular shape that can easily fit into the inside of a tire. The ends of the tube are shown not touching each other in order to clearly illustrate that the tube is not fully contiguous. However, in practice the outside of the two ends of the tube may come into contact with each other. The ends of the tube are capped by hemispherical end pieces 3, 4 that can be molded into the tube during manufacture.

The two ends of the tube 3, 4 are separated, such that there is a first end 3 and a second end 4. Also shown is a valve stem 2, used for inflating the tube once it is installed in the tire. The location of the valve stem 2 is not a critical element of the invention, however for ease of installation, the valve stem is preferably located as shown, midway between the separation of the ends along the tube.

FIG. 1 shows an embodiment where the inner tube 1, along with the ends of the tube, are manufactured (e.g. molded) as a single article. The two ends 3, 4 of the tube are molded into a generally hemispherical shape that closes off the ends of the tube. This allows the device to function as a typical tire inner tube. The valve stem 2 shown is a conventional “Schrader” style stem that is compatible with many current inflation devices. The Schrader valve is a type of valve fitting that opens when depressed. However, other types of valves can be used with this invention, and the type of valve shown in this figure should not act to limit the scope of the invention.

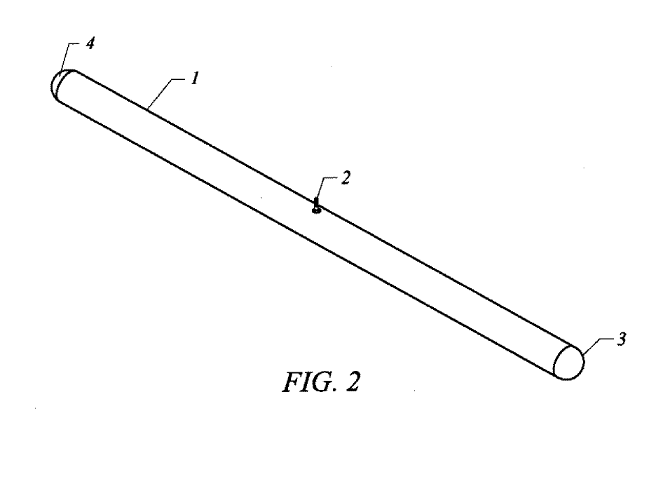

FIG. 2 illustrates a perspective view of an embodiment of the invention. The tube 1 shown in this figure is molded into a generally straight shape. This embodiment allows the tube 1 to be installed inside a tire and placed appropriately, but may simplify the manufacturing of the tube. The ends 3, 4 of the tube, as well as the valve stem 2 type and location, are similar to those shown in FIG. 1.

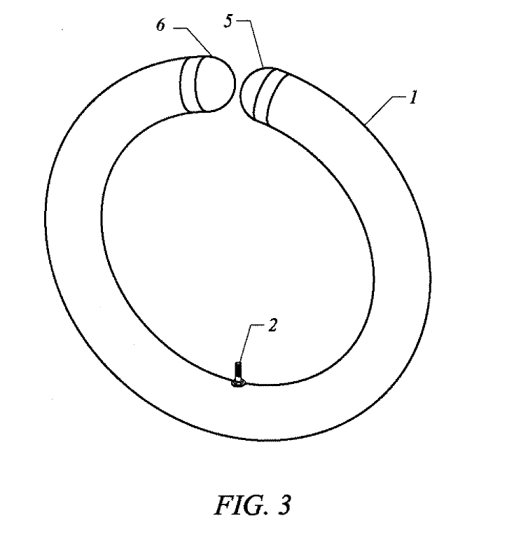

FIG. 3 shows a perspective view of a generally circular shaped embodiment of the invention. The tube shown in this figure is molded into a circular shape that can easily fit into the inside of a tire. The ends of the tube are shown not touching each other in order to clearly illustrate that the tube is not fully contiguous. However, in practice the outside of the two ends of the tube may come into contact with each other. The ends of the tube are capped by generally hemispherical end pieces 5, 6 that can be placed over the end of the tube and bonded onto the ends of the tube to form an air tight seal.

The two ends of the tube 5, 6 are separated, such that there is a first end 5 and a second end 6. Also shown is a valve stem 2, used for inflating the tube once it is installed in the tire. The location of the valve stem 2 is not a critical element of the invention, however for ease of installation, the valve stem is preferably located as shown, midway between the separation of the ends along the tube.

FIG. 3 shows an embodiment where the ends of the tube are manufactured (e.g. molded) as a single article. The two ends 5, 6 of the tube are molded into a generally hemispherical shape that closes off the ends of the tube. This allows the device to function as a typical tire inner tube. The valve stem 2 shown is a conventional “Schrader” style stem that is compatible with many current inflation devices. The Schrader valve is a type of valve fitting that opens when depressed. However, other types of valves can be used with this invention, and the type of valve shown in this figure should not act to limit the scope of the invention.

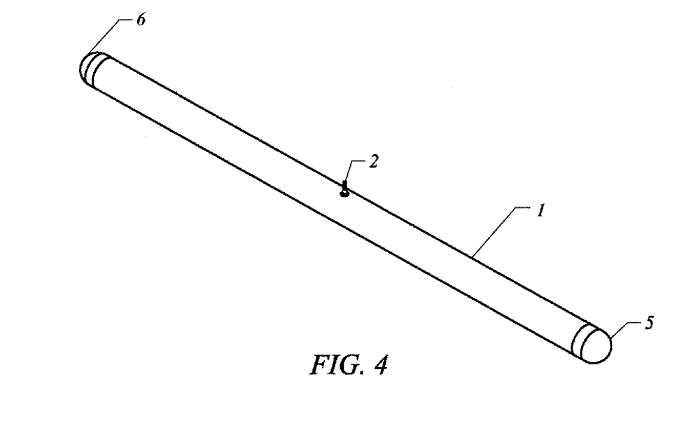

FIG. 4 illustrates a perspective view of an embodiment of the invention. The tube 1 shown in this figure is molded into a generally straight shape. This embodiment allows the tube 1 to be installed inside a tire and placed appropriately, but may simplify the manufacturing of the tube. The ends 5, 6 of the tube, as well as the valve stem 2 type and location, are similar to those shown in FIG. 3.

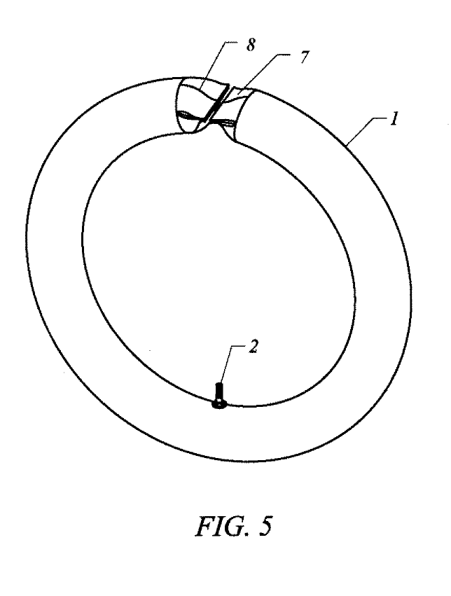

FIG. 5 illustrates a perspective view of an embodiment of the invention. The tube 1 shown in this figure is molded into a circular shape that can easily fit into the inside of a tire. The ends of the tube are shown not touching each other in order to clearly illustrate that the tube is not fully contiguous. However, in practice the outside of the two ends of the tube may come into contact with each other. The ends of the tube 7, 8 are generally pinched together and bonded to form an air tight seal.

The two ends of the tube 7, 8 are separated, such that there is a first end 7 and a second end 8. Also shown is a valve stem 2, used for inflating the tube once it is installed in the tire. The location of the valve stem 2 is not a critical element of the invention, however for ease of installation, the valve stem is preferably located as shown, midway between the separation of the ends along the tube.

FIG. 5 shows an embodiment where the ends of the tube can originally be simply the ends of a tube that has had the ends cut off. The ends can then simply be pinched or pressed together, then molded together. The molding of the ends can be accomplished through a variety of means, including but not limited to glue, heating, etc. The valve stem 2 shown is a conventional “Schrader” style stem that is compatible with many current inflation devices. The Schrader valve is a type of valve fitting that opens when depressed. However, other types of valves can be used with this invention, and the type of valve shown in this figure should not act to limit the scope of the invention.

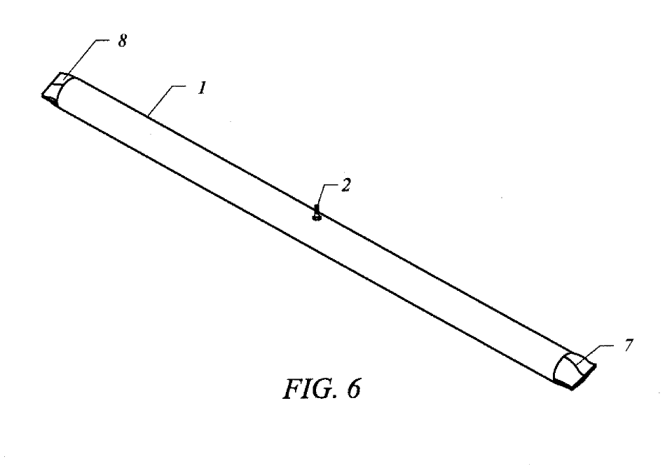

FIG. 6 illustrates a perspective view of an embodiment of the invention. The tube 1 shown in this figure is molded into a generally straight shape. This embodiment allows the tube 1 to be installed inside a tire and placed appropriately, but may simplify the manufacturing of the tube. The ends 7, 8 of the tube, as well as the valve stem 2 type and location, are similar to those shown in FIG. 5.

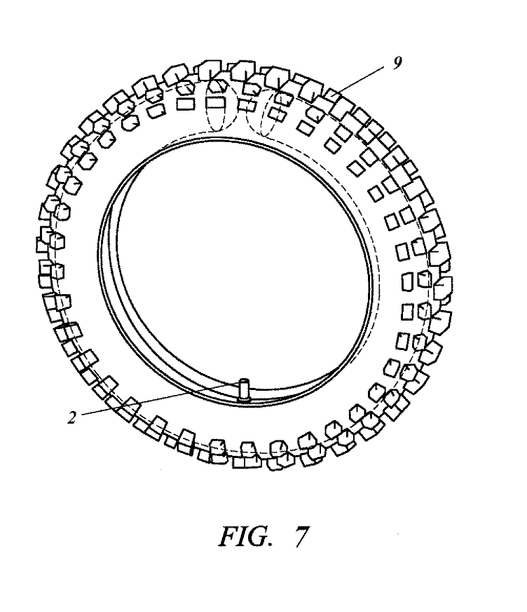

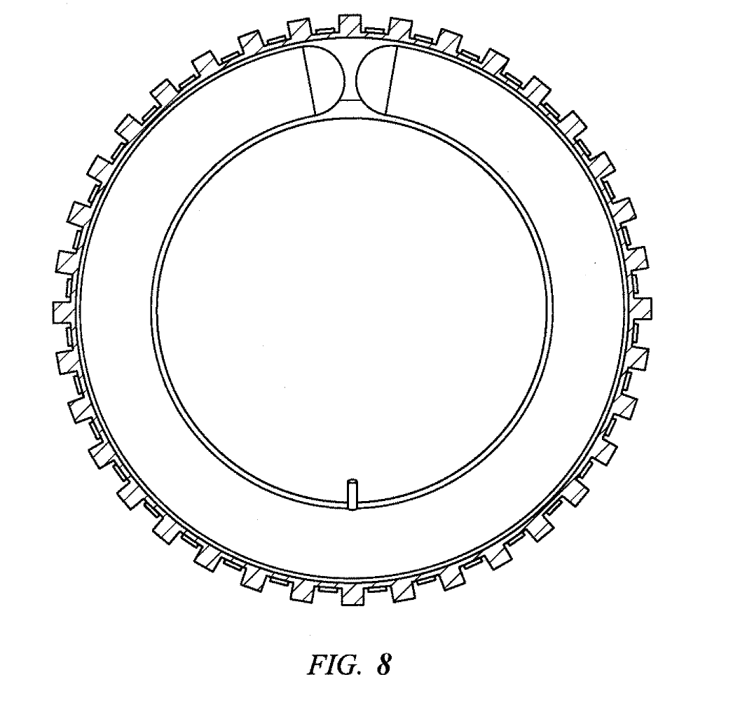

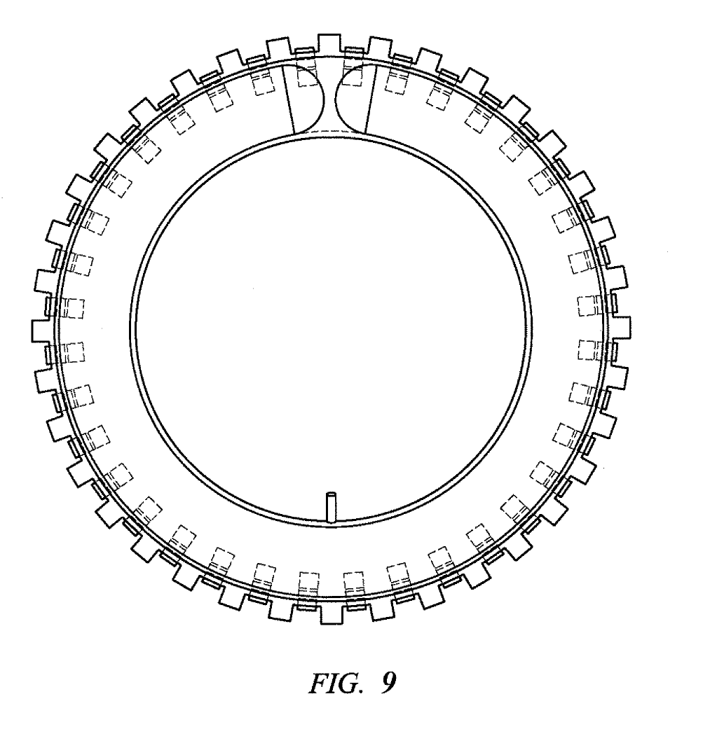

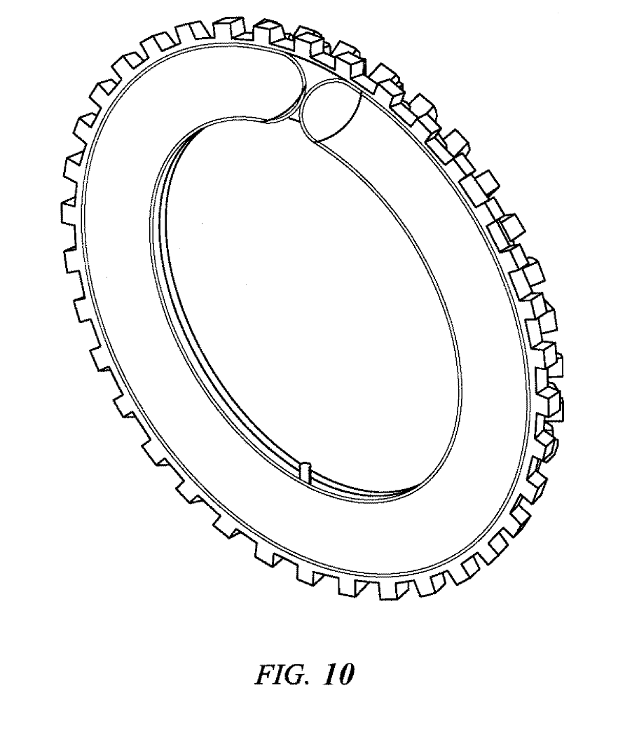

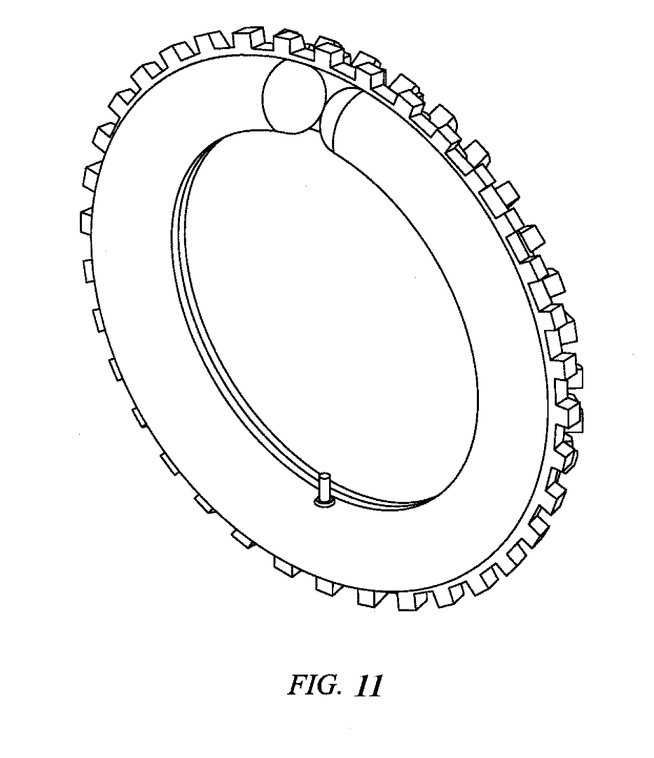

FIGS. 7-11 illustrate various angles and perspectives of an embodiment of the invention. Here, the inner tube is, to a large extent, enclosed by an exterior tire 9. The tire 9 can be made from a variety of materials, including rubber and or synthetic materials. The tube and tire shown in this figure could be used on a bicycle, motorcycle, or any other vehicle that uses tires and inner tubes. The tube shown in these drawings is similar to that shown in FIG. 1, however any of the embodiments described herein could work in the same or similar manner. The end caps shown in FIGS. 3 and 4, as well as the pinched end type shown in FIGS. 5 and 6 would work in the same or similar manner as shown in FIGS. 7-11.

The valve stem 2 shown is a conventional “Schrader” style stem that is compatible with many current inflation devices. The Schrader valve is a type of valve fitting that opens when depressed. However, other types of valves can be used with this invention, and the type of valve shown in this figure should not act to limit the scope of the invention.

I claim:

1. An inner tube for a tire comprising:
a. an air tight, flexible, inflatable tube, having a first end and a second end, and
b. a valve positioned on the tube at a point between the first and second ends through which air can be introduced into the tube.

2. The inner tube of claim 1 wherein when the tube is capable of being wrapped around a wheel.

3. The inner tube of claim 1 wherein when the tube is capable of being positioned within the cavity of a tire.

4. The inner tube of claim 1 in which said tube is made of rubber.

5. The inner tube of claim 1 wherein the valve is functionally integrated into the tube.

6. The inner tube of claim 1 wherein said valve is located at a half way point between the first and second ends.

7. The inner tube of claim 1 having a near circular configuration wherein the first and second ends come into close approximation of each other.

8. The inner tube of claim 1 wherein the first and second ends are molded as an integral part of the tube.

9. The inner tube of claim 1 wherein each of the ends are heat sealed to make the tube air tight.

10. The inner tube of claim 1 wherein each of the ends are pinched together and bonded to make the tube air tight.

11. The inner tube of claim 1 wherein the valve is a conventional inner tube valve.

12. The inner tube of claim 1 wherein the valve is a Schrader type valve.

13. The inner tube of claim 1 wherein the tube is elongated.

14. An article of manufacture comprising:
a. a wheel rim;
b. a tire surrounding the rim; and
c. an inner tube surrounding the wheel positioned within the cavity of the tire, the inner tube comprising:
i. an air tight, flexible, inflatable tube, having a first end and a second end; and
ii. a valve positioned on the tube at a point between the first and second ends through which air can be introduced into the tube.

15. The article of manufacture of claim 14 wherein the first and second ends of the tube come into close approximation with each other.

16. The article of claim 14 wherein the tube is made of rubber.

17. The article of claim 14 in which the valve is functionally integrated into the tube and projects through an orifice in the rim.

18. The article of claim 14 wherein the valve is located at a half way point between the first and second ends.

19. The article of claim 14 wherein the inner tube has a near circular configuration, and the first and second ends come into close approximation of each other.

20. The article of claim 14 wherein the first and second ends of said inner tube are molded as integral part of the tube.

21. The article of claim 14 wherein said valve is a conventional inner tube valve.
